(19) United States
(12) Patent Application Publication
(10) Pub. No.: US 2003/0074655 A1
(43) Pub. Date: Apr. 17, 2003

(54) Method and apparatus for alias analysis for restricted pointers

(76) Inventor: Arch D. Robison, Champaign, IL (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/964,763

(22) Filed: Sep. 27, 2001

(51) Int. Cl. G06F 9/45

(52) U.S. Cl. 717/162

(57) ABSTRACT

In an embodiment, a method includes receiving a code segment having a plurality of instructions. The code segment includes an outer scope and a number of inner scopes. Additionally, the plurality of instructions comprise a number of pointers, wherein at least one of the number of pointers is restricted. The method also includes determining, within one of the number of inner scopes, whether at least two pointers of the number of pointers are aliases.

### BACKGROUND OF THE INVENTION

1. Field of the Invention

The invention relates to the field of compilers. More specifically the invention relates to a method and system for alias analysis for restricted pointers for code compilation.

2. Background of the Invention

Programming languages, such as C, support qualifiers such as “restrict” to denote a special type of pointer. It should be noted that the “restrict” qualifier defines the type of pointer and not the data type of the object accessed by the pointer. Declaring a restricted pointer indicates that in the restricted pointer's scope, its target will not be accessed through any pointer that was not copied from the restricted pointer. Furthermore, the rules dictate that two restricted pointers cannot be used to access the same object while they are both within scope. Once a pointer is declared as restricted, the compiler can presume that the restricted pointer is not improperly aliased by other pointers. This presumption allows a compiler to optimize a program code segment where the optimized code delivers reliable results. Optimized program code segments have faster execution times than non-optimized code segments. Therefore, compiler optimization assists programmers in creating faster running programs.

Because “restrict” analysis of pointers outside the scope of a pointer is complicated, current techniques perform analysis for those “restrict” pointers that are parameters or are declared in the outermost block scope for a given set of code. With this approach, code in the outermost scope may be optimized with regard to a “restrict” pointer analysis. However, inner-scope code blocks cannot be reliably optimized. Analyzing restricted pointers outside their scope will allow compilers to reliably optimize inner-scope code blocks.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary system 100 for performing an analysis for “restricted” pointers according to embodiments of the present invention.

FIG. 2 illustrates a data flow diagram for generation of a number of executable program units according to one embodiment of the invention.

FIG. 3 is a block diagram illustrating a method for performing alias analysis of restricted pointers according to one embodiment of the invention.

FIG. 4 is a set of instructions containing restricted pointers, according to embodiments of the present invention.

FIG. 5 is a lattice used according to one embodiment of the invention.

FIG. 6 is a block diagram illustrating a method for determining the flow of pointers according to one embodiment of the invention.

FIG. 7 illustrates a corresponding pseudo code for the method illustrated in FIG. 6 for determining the flow of pointers, according to embodiments of the present invention.

FIG. 8 is a table illustrating the results of method 600 according to one embodiment of the invention.

FIG. 9 is a flow chart illustrating a method for determining the scope of restricted pointers relative to other pointers in a code segment, according to embodiments of the present invention.

FIG. 10 is a pseudo code procedure for determining the scope of restricted pointers relative to other pointers in a code segment.

FIG. 11 is a matrix illustrating the results of a method for determining the scope of restricted pointers relative to other pointers in a code segment.

FIG. 12 illustrates a flowchart for determining whether two pointers could be aliases, according to embodiments of the present invention.

FIG. 13 illustrates a corresponding pseudo code for determining whether two pointers could be aliases, according to embodiments of the present invention.

### DETAILED DESCRIPTION OF THE INVENTION

A method and system for alias analysis for restricted pointers are described. In the following description, for purposes of explanation, numerous specific details are set forth in order to provide a thorough understanding of the present invention. It will be evident, however, to one skilled in the art that the present invention may be practiced without these specific details. Additionally, embodiments of the present invention are described within the C programming language. However, this is by way of example and not by way of limitation, as embodiments of the present invention can be incorporated into any other programming language that incorporates alias analysis into compilation of code written into such languages. For example, in one embodiment, the methods and system for restrict analysis provided herein could be employed in the Formula Translation (“FORTRAN”) programming language.

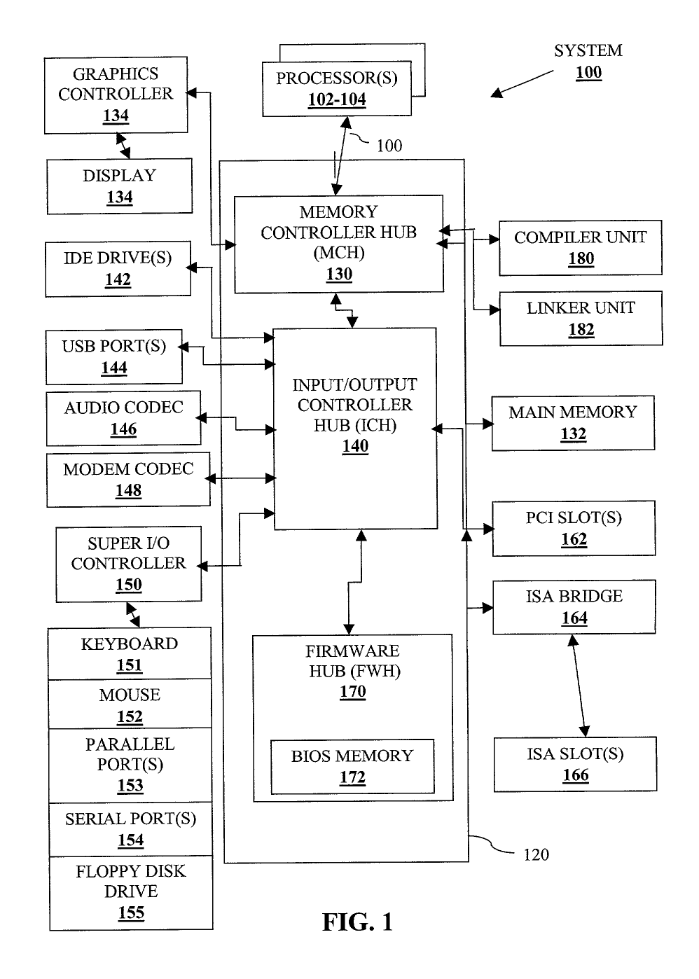

FIG. 1 illustrates an exemplary system 100 for performing an analysis for “restricted” pointers according to embodiments of the present invention. Although described in the context of system 100, the present invention may be implemented in any suitable computer system comprising any suitable one or more integrated circuits.

As illustrated in FIG. 1, computer system 100 comprises processor 102. Computer system 100 also includes processor bus 110, and chipset 120. Processor 102 and chipset 120 are coupled to processor bus 110. Processor 102 may each comprise any suitable processor architecture and for one embodiment comprise an Intel® Architecture used, for example, in the Pentium® family of processors available from Intel® Corporation of Santa Clara, Calif. Computer system 100 for other embodiments may comprise one, three, or more processors any of which may execute a set of instructions that are in accordance with embodiments of the present invention.

Chipset 120 for one embodiment comprises memory controller hub (MCH) 130, input/output (I/O) controller hub (ICH) 140, and firmware hub (FWH) 170. MCH 130, ICH 140, and FWH 170 may each comprise any suitable circuitry and for one embodiment is each formed as a separate integrated circuit chip. Chipset 120 for other embodiments may comprise any suitable one or more integrated circuit devices.

MCH 130 may comprise any suitable interface controllers to provide for any suitable communication link to processor bus 110 and/or to any suitable device or component in communication with MCH 130. MCH 130 for one embodiment provides suitable arbitration, buffering, and coherency management for each interface.

MCH 130 is coupled to processor bus 110 and provides an interface to processors 102 and 104 over processor bus 110. Processor 102 and/or processor 104 may alternatively be combined with MCH 130 to form a single chip. MCH 130 for one embodiment also provides an interface to a main memory 132 and a graphics controller 134 each coupled to MCH 130. Main memory 132 stores data and/or instructions, for example, for computer system 100 and may comprise any suitable memory, such as a dynamic random access memory (DRAM) for example. Graphics controller 134 controls the display of information on a suitable display 136, such as a cathode ray tube (CRT) or liquid crystal display (LCD) for example, coupled to graphics controller 134. MCH 130 for one embodiment interfaces with graphics controller 134 through an accelerated graphics port (AGP). Graphics controller 134 for one embodiment may alternatively be combined with MCH 130 to form a single chip.

MCH 130 is also coupled to ICH 140 to provide access to ICH 140 through a hub interface. ICH 140 provides an interface to I/O devices or peripheral components for computer system 100. ICH 140 may comprise any suitable interface controllers to provide for any suitable communication link to MCH 130 and/or to any suitable device or component in communication with ICH 140. ICH 140 for one embodiment provides suitable arbitration and buffering for each interface.

For one embodiment, ICH 140 provides an interface to one or more suitable integrated drive electronics (IDE) drives 142, such as a hard disk drive (HDD) or compact disc read only memory (CD ROM) drive for example, to store data and/or instructions for example, one or more suitable universal serial bus (USB) devices through one or more USB ports 144, an audio coder/decoder (codec) 146, and a modem codec 148. ICH 140 for one embodiment also provides an interface through a super I/O controller 150 to a keyboard 151, a mouse 152, one or more suitable devices, such as a printer for example, through one or more parallel ports 153, one or more suitable devices through one or more serial ports 154, and a floppy disk drive 155. ICH 140 for one embodiment further provides an interface to one or more suitable peripheral component interconnect (PCI) devices coupled to ICH 140 through one or more PCI slots 162 on a PCI bus and an interface to one or more suitable industry standard architecture (ISA) devices coupled to ICH 140 by the PCI bus through an ISA bridge 164. ISA bridge 164 interfaces with one or more ISA devices through one or more ISA slots 166 on an ISA bus.

ICH 140 is also coupled to FWH 170 to provide an interface to FWH 170. FWH 170 may comprise any suitable interface controller to provide for any suitable communication link to ICH 140. FWH 170 for one embodiment may share at least a portion of the interface between ICH 140 and super I/O controller 150. FWH 170 comprises a basic input/output system (BIOS) memory 172 to store suitable system and/or video BIOS software. BIOS memory 172 may comprise any suitable non-volatile memory, such as a flash memory for example.

Additionally, computer system 100 includes compiler unit 180 and linker unit 182. In an embodiment, compiler unit 180 and linker unit 182 can be processes or tasks that can reside within main memory 132 and/or processor 102 and can be executed within processor 102. However, embodiments of the present invention are not so limited, as compiler unit 180 and linker unit 182 can be different types of hardware (such as digital logic) executing the processing described herein (which is described in more detail below).

Accordingly, computer system 100 includes a machine-readable medium on which is stored a set of instructions (i.e., software) embodying any one, or all, of the methodologies to be described below. For example, software can reside, completely or at least partially, within main memory 132 and/or within processor 102. For the purposes of this specification, the term “machine-readable medium” shall be taken to include any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

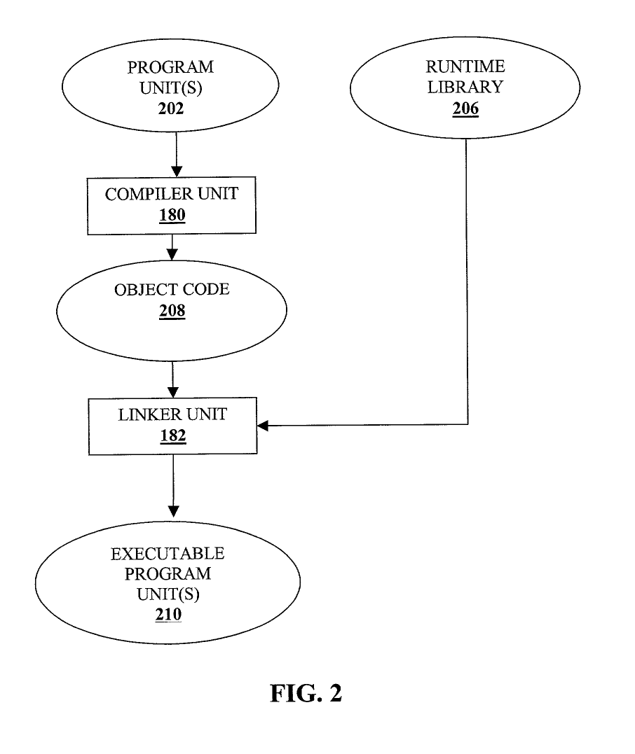

FIG. 2 illustrates a data flow diagram for generation of a number of executable program units that include instances of alias analysis for restricted pointers according to one embodiment of the invention. Program unit(s) 202 can be one to a number of such program units inputted into compiler unit 180. Examples of a program unit include a program or module, or a subroutine or function within a given program. In one embodiment, program unit(s) 202 are source code. The types of source code may include, but are not limited to, C, C++, Fortran, Java, Pascal, etc. However, embodiments of the present invention are not limited to program unit(s) 202 being written at the source code level. In other embodiments, such units can be at other levels, such as assembly code. Moreover, executable program unit(s) 208 that are output from linker unit 182 (which is described in more detail below) can be executed in a multi-processor shared memory environment. Other embodiments may defer the analysis until program execution time.

Compiler unit 180 receives program units 202 and generates object code 204. Compiler unit 180 can be different compilers for different operating systems and/or different hardware. In an embodiment, the compilation of translated program unit(s) 202 is based on the C99 standard (ISO/IEC 9899:1999 (E)).

Linker unit 182 receives object code 204 and runtime library 206 and generates executable code 208. Runtime library 206 can include one to a number of different functions or routines that are incorporated into the object code 204. Additionally, executable program unit(s) 204 can be executed across a number of different operating system platforms, including, but not limited to, different versions of UNIX, Microsoft Windows™, real time operating systems such as VxWorks™, etc.

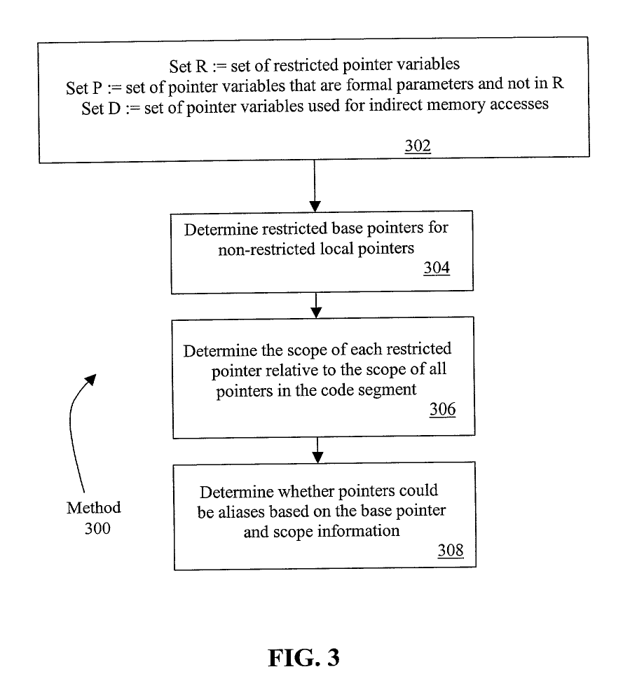

FIG. 3 is a block diagram illustrating a method for performing alias analysis of restricted pointers according to one embodiment of the invention. More specifically, FIG. 3 contains method 300, employed by compiler unit 180 for performing alias analysis of restricted pointers. Method 300 commences with the creation of sets R, P, and D for a given code segment, at process block 302. Set R is the set of restricted pointer variables in the given code segment. Set P is the set of pointer variables that are formal parameters not in set R. Set D is the set of all pointer variables used for indirect memory accesses.

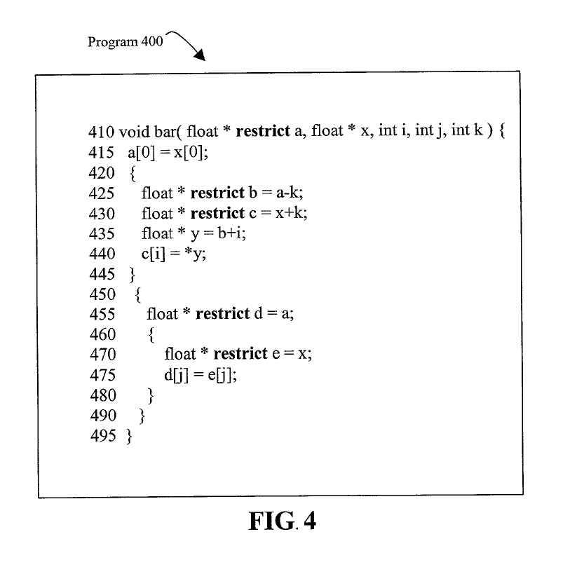

To help illustrate, FIG. 4 is a set of instructions containing restricted pointers, according to embodiments of the present invention. More specifically, FIG. 4 contains program 400, a C language program comprising restricted pointers. Beginning with FIG. 4, in program 400, the pointer variable ‘a’ is declared as a “restrict” pointer. Declaring a restricted pointer using the restrict qualifier indicates that in the restricted pointer's scope, its target will not be accessed through any pointer that was not copied from the restricted pointer. An access may be in the form of an indirect read or write through a pointer. Scope is the portion of the program to which a declaration applies. In an embodiment, in the C programming language, scope is denoted by an open brace (‘{’) followed by a close brace (‘}’). There may be many open and close braces nested together, denoting inner scopes and outer scopes. For example, in program 400 line 425, the scope of restricted pointer ‘b’ begins with the open brace on line 420 and ends with the close brace on line 445. However, the program block containing ‘b’ is within the scope of the block beginning with the open brace on line 410 and ending with the closed brace on line 495. Therefore, ‘b’ is restricted within an inner scope block.

In program 400, upon entry, pointer ‘a’ is the sole access path to whatever entities it is used to access. Other pointers declared as restricted pointers are ‘b’, ‘c’, ‘d’, and ‘e’. Referring to line 425 of program 400, the assignment “float * restrict b=a−k” means that within the scope of pointer ‘b’, pointer ‘b’ is the sole initial access path to whatever memory locations pointer ‘b’ is used to access. However, restricted pointer ‘b’ can be copied to unrestricted pointers as in “y=b+i”, at program 400 line 435. When a pointer is outside of its scope, “restrict” is inapplicable, and thus does not indicate that two pointers will not be used to access the same object. For example, referring to program 400 line 130, ‘d[j]’ and ‘b’ could reference the same memory location because ‘d[j]’ is outside the scope of ‘b’, and ‘b’ is outside the scope of ‘d[j]’.

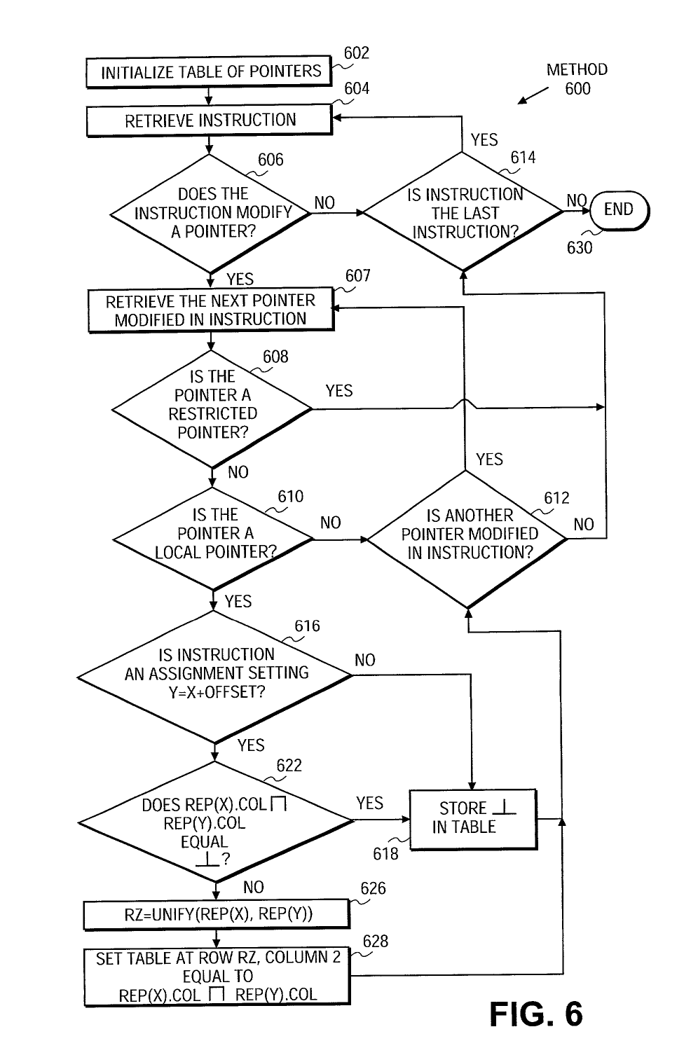

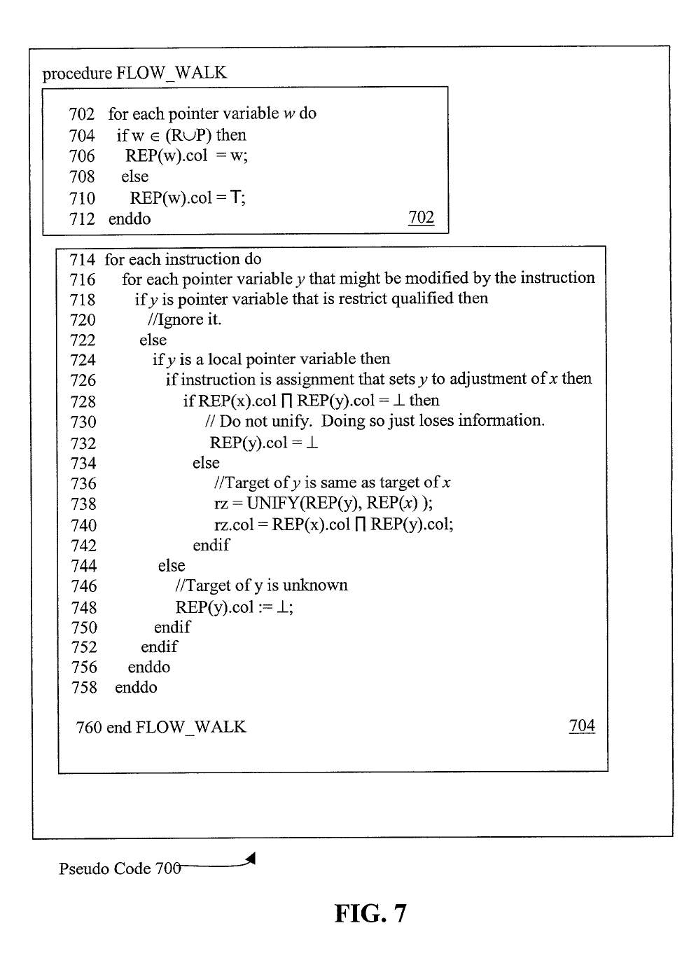

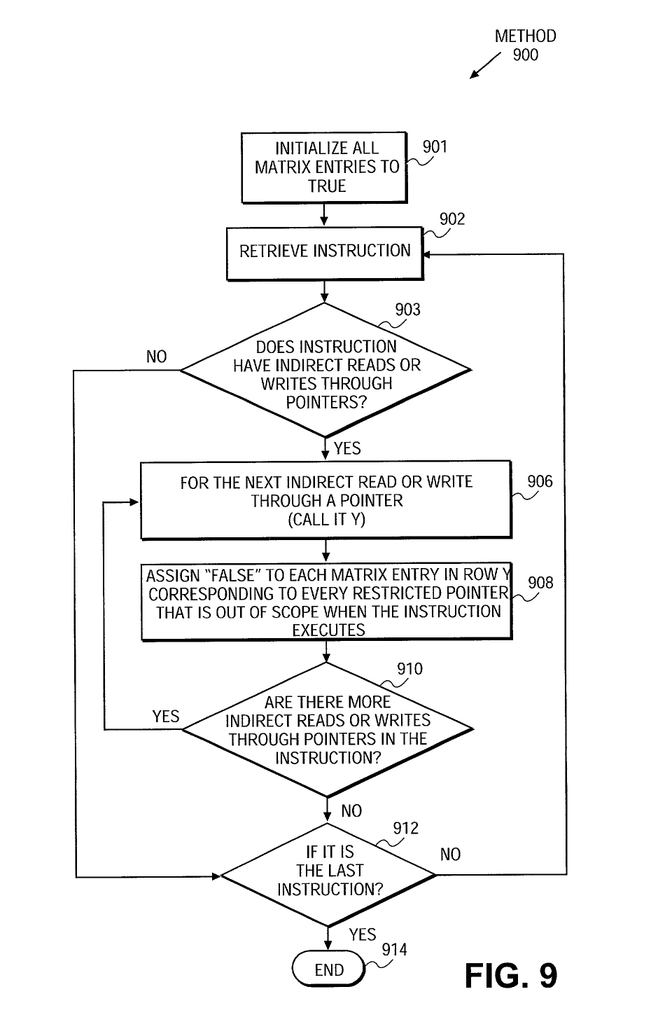

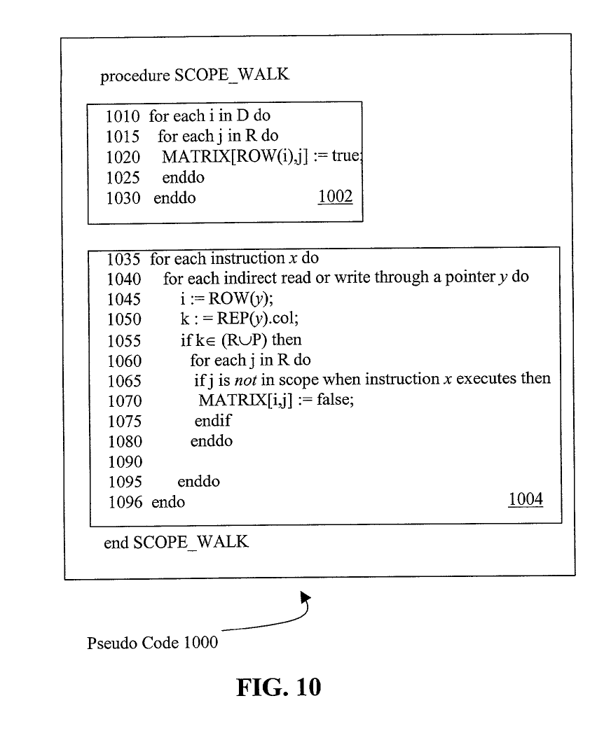

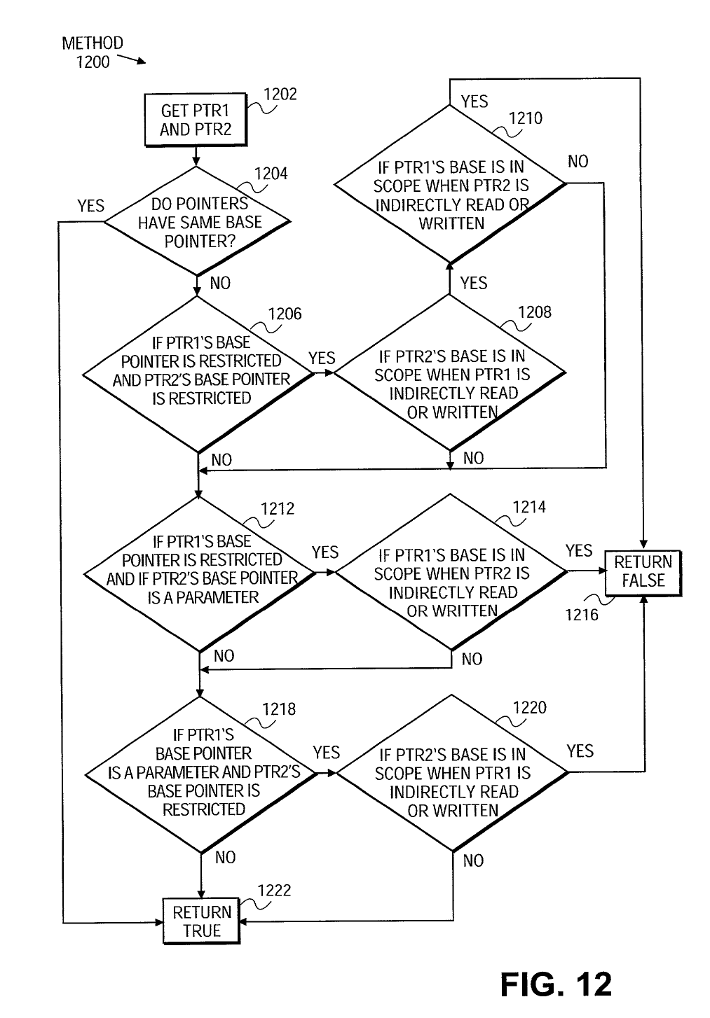

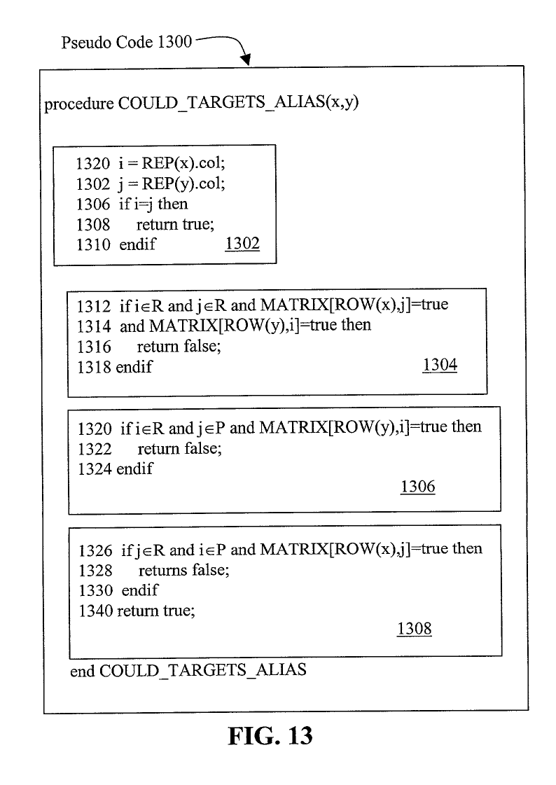

Returning to FIG. 3, to help illustrate how sets R, P, and D are determined, at process block 302, if the given code segment is program 400, the sets are as follows: R={‘a’,‘b’,‘c’,‘d’,‘e’}, P−{‘x’}, and D={‘a’,‘b’,‘c’,‘d’,‘e’,‘x’,‘y’}. Associated with each element p in set D is a unique integer index, denoted ROW(p). The notation ROW(D) denotes the set of all such integer indices. Compiler unit 180 determines base pointers for nonrestricted pointers, at process block 304. One embodiment of a method for determining base pointers for nonrestricted pointers is illustrated in FIGS. 6 and 7, and discussed in greater detail below. At process block 306, compiler unit 180 determines the scope of each restricted pointer relative to the scope of all pointers for a given code segment. An embodiment of a method for determining the scope of each restricted pointer relative to the scope of all pointers is illustrated in FIGS. 9 and 10, and discussed in greater detail below. At process block 308, compiler unit 180 determines whether pointers could be aliases based on the base pointer and scope information acquired at process blocks 404 and 406, respectively. An embodiment of a method for determining whether pointers could be aliases is illustrated in FIGS. 12 and 13, and discussed in greater detail below.

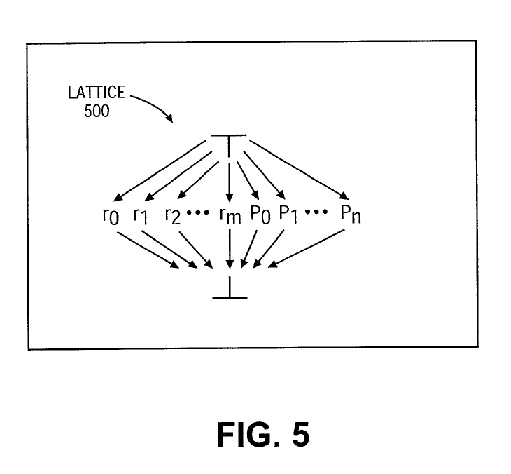

FIG. 5 is a lattice used according to one embodiment of the invention. In an embodiment, a record used for union-find operations is associated with each pointer variable. Union-find operations include a union operation and a find operation. The union operation combines given elements into a set, and the find operation returns a token representative of the set. The record also contains a “col” field, which holds a lattice value from lattice 500. Lattice 500 has a top “T”, a bottom “⊥”, and an element for each element in R∪P. In the lattice, top represents having a choice of any of the elements in the lattice, while bottom (“⊥”) represents having no choice of elements. Given a variable x, the notation REP(x) means a reference to the corresponding representative record in its union-find set. Thus REP(x).col denotes the lattice value associated with the union-find set.

FIG. 6 is a block diagram illustrating a method for determining the flow of pointers according to one embodiment of the invention. This flow analysis illustrated by method 600 is done to determine which pointers are based on pointers in R∪P. Each pointer that is assigned the value of another pointer from R∪P in an instruction within a given code segment is said to have the other pointer as its “base” pointer. To further illustrate, FIG. 7 includes a corresponding pseudo code for the method illustrated in FIG. 6 for determining the flow of pointers, according to embodiments of the present invention. In an embodiment, compiler unit 180 uses sets R, P, and D created by executing method 400, as described above. At process block 602, compiler unit 180 begins method 600 by initializing a table of pointer variables. Additionally, the corresponding pseudo code within pseudo code 700 of FIG. 7 is shown by pseudo code block 702. Compiler unit 180 executes the loop in pseudo code 700 to initialize each table location. For each pointer w in set D, if wε(R∪P), compiler unit 180 puts the value w in the table at row w, second column, otherwise it puts ‘T’. Thus, initially, parameters and restricted pointers are considered as being their own base pointers. Also, initially, pointers that are not parameters or restricted pointers are given base pointer values of ‘T’ because compiler unit 180 may later determine the base pointer is a parameter or restricted pointer. That is, referring to lattice 500, a pointer's base pointer may be chosen from the lattice elements.

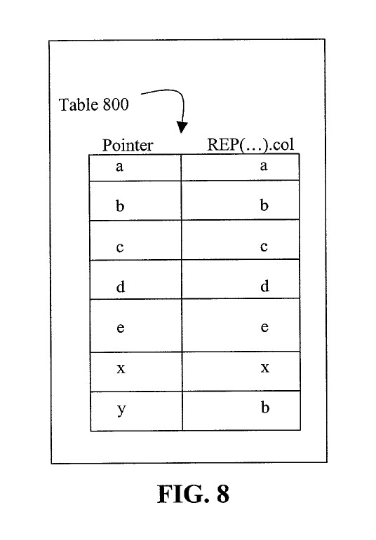

FIG. 8 is a table illustrating the results of method 600 according to one embodiment of the invention. In an embodiment, the table is an n by 2 matrix having n rows, one for each pointer in set D. The table has two columns, one for the pointers in set D, and one for base pointers associated with each pointer in set D. For example, in FIG. 8, table 800 has seven rows, one for each pointer in program 400. Also, table 800 has two colunms, one for each pointer in program 400, and another for base pointers associated with each pointer in program 400.

Referring to FIG. 6, at process block 604, compiler unit 180 gets the next instruction from a block of code taken as input. For example, taking program 400 as input, compiler unit 180 gets the following instruction from line 415:a[0]=x[0]. (Line 410 merely declares the interface to routine bar, and hence is not an instruction.) At process block 606, compiler unit 180 determines whether the instruction modifies a pointer contained in the instruction. For example, the program 400 instruction at line 425 modifies pointer ‘b’. That is, after processor 102 executes that instruction, pointer ‘b’ points to a new location. If the instruction does not modify a pointer, compiler unit 180 gets the next instruction, at process block 604. Conversely, if the instruction modifies a pointer, compiler unit 180 continues method 600 at process block 607. At process block 607, compiler unit 180 gets the next pointer ‘y’ modified by the instruction. At process block 608, compiler unit 180 determines whether the modified pointer is a restricted pointer. In one embodiment, compiler unit 180 determines whether pointers are restricted pointers by comparing them with each element in set R. If the modified pointer is a restricted pointer, compiler unit 180 gets the next instruction, at process block 604. For example, consider the instruction at line 340 of program 400. This instruction modifies pointer ‘b’, and pointer ‘b’ is a restricted pointer. Because ‘b’ is a restricted pointer, no further analysis is needed, as “b's” base pointer was recorded in the table upon initialization.

If compiler unit 180 determines that the modified pointer is a local pointer, at process block 610, it goes to process block 616, otherwise it goes to process block 612, where compiler unit 180 determines whether another pointer is modified in the instruction. If another pointer is modified in the instruction, method 600 continues at process block 607. If no other pointer is modified in the instruction, compiler unit 180 determines whether the instruction is the last instruction, at process block 614. Method 600 ends at process block 630 if the instruction was the last instruction, otherwise it retrieves the next instruction at process block 604. In an embodiment, a local pointer is a pointer whose scope is within a given code segment. For example, in program 400, ‘c’ is local to function “bar” because is it declared within bar's scope. At process block 616, compiler unit 180 determines whether the pointer is assigned the value of another pointer plus some offset. If the pointer is not assigned the value of another pointer plus some offset, compiler unit 180 puts a “⊥” in the table, at the pointer's row, column 2, at process block 618. Bottom (“⊥”) indicates that a pointer's base pointer is undeterminable. In other words, there is no choice from the elements in lattice 500. For example, assuming ‘b’ is a pointer, if the instruction were “float *y=Somefunction(b)+I”, if the meaning of Somefunction was not known, the instruction would be considered to be not in pointer plus offset form. Given this instruction, compiler unit 180 cannot determine how this assignment affects ‘y’ because the result of Somefunction(b) is unknown. Therefore, because the target of y is unknown, compiler unit 180 puts “⊥” in the table. Upon completing the operation at process block 618, compiler unit 180 determines whether another pointer is modified in the instruction at process block 612.

At process block 622, compiler unit 180 determines whether REP(x).col “meet” REP(y).col equals “⊥”. The notation is REP(x).col [symbol] REP(y).col=⊥. Compiler unit 180 finds REP(y), for a pointer y, by performing a union-find operation on y. In method 600, the REP( ) function returns a row index for the table. For example, using ‘a’ from program 400, REP(a) is the index to a's row in table 800.

REP( ).col is the table value stored in some row, second column. For example, REP(y).col is the table value at y's row, second column. That is, REP(y).col is ‘b’.

The meet operation ( [symbol] ) is performed on two elements. For example, in this case, the two elements are REP(x).col and REP(y).col. Performing the meet operation on elements REP(x).col and REP(x).col renders results as follows. If the element values are the same, the result is either element value. If one element value is [symbol] , the result is the other element value. If the element values are different or one element value is [symbol] , the result is “⊥”. For example, for program 400 pointers ‘y’ and ‘b’, REP(y).col meet REP(b).col is determined as follows. The element value for REP(y).col is ‘b’ and the element value for REP(b).col is ‘b’. Because both element values are the same, REP(y).col meet REP(b).col is ‘b’.

If REP(x).col meet REP(y).col equals “⊥”, compiler unit 180 puts the value “⊥” in the table at x's row, column 2, at process block 618. If REP(x).col meet REP(y).col does not equal “⊥”, the compiler unit 180 assigns variable rz the result of UNIFY(REP(y), REP(x)), at process block 626. The function UNIFY(REP(y), REP(x)) unifies the sets containing REP(y) and REP(x) returning one set as its result. For example, for program 400 pointers ‘a’ and ‘b’, UNIFY(REP(a), REP(b)) returns the set {a, b}.

At process block 628, compiler unit 180 puts the value REP(x).col meet REP(y).col into the table at row rz, second column. Additionally, the corresponding pseudo code within pseudo code 700 of FIG. 7 is shown by pseudo code block 704. Upon completing process block 628, compiler unit 180 continues method 600 at process block 614. Compiler unit 180 continues performing method 600 operations until it reaches the end of the given code segment, at process block 630.

Performing method 600 while using program 400 as input, creates table 800. The flow analysis performed by method 600 is done to determine which pointers are based on pointers in R∪P. As noted above, R∪P is the set containing all restricted pointers and all pointers that are parameters. Each pointer that is assigned the value of another pointer in R∪P is said to have the other pointer as its “base” pointer. Also each pointer in R∪P is said to be its own base pointer. Referring to program 400, pointers ‘a’, ‘b’, ‘c’, ‘d’, ‘e’, and ‘x’ are in R∪P, hence they are their own base pointers. Therefore, the first six entries in the second column of table 800 are identical to the first six entries in column one. As for pointer ‘y’, compiler unit 180 determined that its base pointer was ‘b’; thus ‘b’ appears in the last row, second column, of table 800. In one embodiment, the table constructed by performing method 600 will be used by method 1200, as described below.

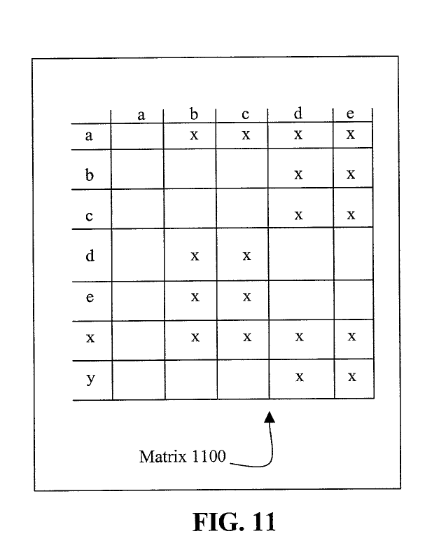

FIG. 9 is a flow chart illustrating a method for determining the scope of restricted pointers relative to other pointers in a code segment, according to embodiments of the present invention. FIG. 10 is a pseudo code procedure for determining the scope of restricted pointers relative to other pointers in a code segment. More specifically, FIG. 10 contains pseudo code 1000 for determining the scope of restricted pointers according to and corresponding with method 900. At process block 901, compiler unit 180 initializes all values of an n×m matrix. The matrix has a row for every pointer in set D, and a column for every pointer in set R. The corresponding pseudo code is contained in pseudo code block 1002. FIG. 11 is a matrix illustrating the results of a method for determining the scope of restricted pointers relative to other pointers in a code segment. FIG. 11 contains matrix 1100, which has 7 rows, one for each pointer used in an indirect reference, and 5 columns, one for each restricted pointer. Pseudo code block 1002 contains the corresponding pseudo code for initializing the matrix. In an embodiment, compiler unit 180 executes the loops contained in pseudo code block 1002 to initialize every matrix location to “true”. “True” is indicated by a blank entry in matrix 1100.

At process block 902, compiler unit 180 gets the next instruction in the code segment. At process block 904, if the instruction indirectly reads or writes through a pointer, method 900 continues with process block 906. At process block 906, compiler unit 180 goes to the next indirect read or write through a pointer. The pointer is denoted as ‘y’. At process block 908, compiler unit 180 assigns “false” to every matrix location corresponding to that pointer and to each restricted pointer that is out of scope when the instruction executes. For example, the instruction on line 320 of program 400 indirectly writes through pointer ‘a’. When the instruction executes, restricted pointers ‘b’, ‘c’, ‘d’, and ‘e’ are not in scope, so compiler unit 180 sets the corresponding row ‘a’ matrix entries to “false”. Pseudo code block 1004 contains the corresponding pseudo code. On line 1040 of pseudo code 1000, compiler unit 180 determines which matrix row contains the indirectly read or written pointer. On lines 1045-1055 of pseudo code 1000, compiler unit 180 determines whether the pointer's base pointer is a restricted pointer or a parameter. If the base pointer is a restricted pointer or a parameter, compiler unit 180 determines which restricted pointers are not in scope when the instruction executes. Compiler unit 180 assigns the value “false” to each matrix location corresponding to the pointer and to the out of scope restricted pointer.

Referring to FIG. 9, at process block 910 compiler unit 180 determines whether there are any more indirect reads or writes through pointers. If there are more indirect reads or writes through pointers, method 900 continues at process block 906, otherwise method 900 continues at process block 912. At process block 912, compiler unit 180 determines whether the instruction was the last instruction in the given code segment. If it is the last instruction, compiler unit 180 ends method 900 at process block 914, otherwise it gets the next instruction, at process block 902.

Referring to FIG. 11, matrix 1100 illustrates the results of performing method 900 on program 400. An “x” mark represents a matrix location containing a value of “false”. As noted above, “false” indicates that the restricted pointer in that column is out of scope for an instruction that indirectly reads or writes through the pointer in the corresponding row. A blank location indicates true. That is, the corresponding restricted pointer is in scope when the corresponding pointer is indirectly read or written through. For example, consider the following instruction at program 400 line 415:a[0]=x[0]. Restricted pointers ‘b’, ‘c’, ‘d’, and ‘e’ are out of scope when this instruction executes, so their corresponding matrix locations are set to “false”. Restricted pointer ‘a’ is in scope, so its location is left blank.

FIG. 12 illustrates a flowchart for determining whether two pointers could be aliases, according to embodiments of the present invention. FIG. 12 contains method 1200 for determining whether two pointers could be aliases for the same memory location. FIG. 13 illustrates a corresponding pseudo code for determining whether two pointers could be aliases, according to embodiments of the present invention. FIG. 13 contains pseudo code 1300 for determining whether two pointers could be aliases. Method 1200 commences at process block 1202, where compiler unit 180 takes two pointers as input. The input pointers are ptr1 and ptr2. At process block 1204, compiler unit 1204 determines whether the pointers have the same base pointer. In an embodiment, compiler unit 180 looks up each pointer's base pointer in the table constructed from performing method 600. Table 800 illustrates one embodiment of the table constructed by performing method 600. If the base pointers are the same, method 1200 returns “true”, at process block 1222. When “true” is returned, compiler unit 180 has determined that ptr1 and ptr2 could be aliases. For example, given pointers ‘y’ and ‘b’ from program 400, compiler unit 180 would look in the table 800 to determine their base pointers. Upon discovering that the base pointers are the same, compiler unit 180 returns “true”. Pseudo code block 1302 contains the corresponding pseudo code for process blocks 1202-1204. If the pointers do not have the same base pointer, compiler unit 180 continues with process block 1206.

Referring to FIG. 12, at process block 1206, compiler unit 180 determines whether ptr1's and ptr2's base pointers are restricted pointers. In an embodiment, compiler unit 180 determines whether the base pointers are restricted pointers by comparing the base pointers retrieved from the table created by performing method 600 to each pointer in set R. If the base pointers are not restricted pointers, compiler unit 180 goes to process block 1212, otherwise it determines whether ptr2 is in scope when ptr1 is indirectly read or written through, at process block 1208. In an embodiment, compiler unit 180 determines whether a pointer has been indirectly read or written through by looking in the matrix formed by performing method 900. If ptr2 is in scope when ptr1 is indirectly read or written through, compiler unit 180 determines whether ptr1 is in scope when ptr2 is indirectly read or written through, at process block 1210. If both ptr1 and ptr2 are in scope when each is indirectly read or written through, method 1200 returns “false”, at process block 1216. When method 1200 returns “false”, ptr1 and ptr2 are not aliases for the same memory location.

For example, in an embodiment, given program 400 pointers ‘d’ and ‘e’, compiler unit 180 determines the base pointers by referring to table 800. Because the base pointers are restricted, compiler unit 180 determines the scope information by referring to matrix 1100. Because each pointer is out of scope when the other pointer is indirectly read or written through, compiler unit 180 returns “false”. That is, the pointers could not be aliases.

The corresponding pseudo code is contained in pseudo code block 1304 of pseudo code 1300. In one embodiment, in pseudo code block 1304, the values for MATRIX[ROW(x),j] and MATRIX[ROW(y),i] are retrieved from the matrix created when compiler unit 180 performed method 900. Therefore, if base pointers i and j are restricted pointers, and if the corresponding matrix values equal “true”, program 1300 returns “false”.

Referring to FIG. 12, at process block 1212, compiler unit 180 determines whether ptr1's base pointer is a restricted pointer and whether ptr2's base pointer is a parameter. In an embodiment, compiler unit 180 determines whether the base pointers are restricted pointers or parameters by comparing the base pointers retrieved from the table created by performing method 600 to each pointer in sets P and R. If ptr1's base pointer is not restricted or if ptr2's base pointer is not a parameter, compiler unit 180 goes to process block 1218. However, if ptr1's base pointer is a restricted pointer and ptr2's base pointer is a parameter, compiler unit 180 determines whether ptr1 is in scope when ptr2 is indirectly read or written, at process block 1214. In an embodiment, compiler unit 180 determines whether a pointer has been indirectly read or written through by looking in the matrix formed by performing method 900. If ptr1 is in scope, method 1200 returns “false”, at process block 1216.

For example, for the pointers ‘a’ and ‘x’ from program 400, let ‘a’ be ptr1 and ‘x’ be ptr2. Because ‘a’ has a restricted base pointer and ‘x’ has a parameter base pointer, method 1200 determines whether ‘a’ is in scope when ‘x’ is indirectly read or written through. In this example, ‘a’ is in scope when ‘x’ is indirectly read, on line 415 of program 400. In matrix 1100, the entry at row ‘a’ column ‘x’ is blank. As noted above, a blank entry indicates “true”. Therefore, method 1200 returns “false”, indicating that the pointers cannot be alias for the same memory location.

Referring to FIG. 12, if ptr1 is not in scope, compiler unit continues at process block 1218. The corresponding pseudo code is contained in pseudo code block 1306. In pseudo code block 1306 of pseudo code 1300, compiler unit 180 determines whether ptr1's base pointer is a restricted pointer and whether ptr2's base pointer is a parameter. If ptr1's base pointer is restricted and ptr2's base pointer is a parameter, compiler unit 180 determines whether the value at MATRIX[ROW(y),i] is “true”. If MATRIX[ROW(y),i] is true, pseudo code 1300 returns “false”. Therefore ptr1 and ptr2 cannot be aliases for the same memory location.

Referring to FIG. 12, at process block 1218, compiler unit 180 determines whether ptr1's base pointer is a parameter and whether ptr2's base pointer is a restricted pointer. In an embodiment, compiler unit 180 determines whether the base pointers are restricted pointers or parameters by comparing the base pointers retrieved from the table created by performing method 600 to each pointer in sets P and R. If ptr1's base pointer is not a parameter or if ptr2's base pointer is not a restricted pointer, method 1200 returns “false”, at process block 1222. If ptr1's base pointer is a parameter and ptr2's base pointer is a restricted pointer, compiler unit 180 goes to process block 1220. At process block 1220, compiler unit 180 determines whether ptr2 is in scope when ptr1 is indirectly read or written. In an embodiment, compiler unit 180 determines whether a pointer has been indirectly read or written through by looking in the matrix formed by performing method 900. If ptr2 is in scope, method 1200 returns “false”, at process block 1216, otherwise it returns “true”, at process block 1222.

The corresponding pseudo code is contained in pseudo code block 1308. In pseudo code block 1308, compiler unit 180 determines whether ptr1's base pointer is a restricted pointer and whether ptr2's base pointer is a parameter. If ptr1's base pointer is not a restricted pointer and ptr2's base pointer is not a parameter, pseudo code 1300 returns “true”. Otherwise, compiler unit 180 determines whether the value at MATRIX[ROW(x),j] is “true”. In an embodiment, the value at MATRIX[row, colum] is the corresponding value stored in the matrix formed by performing the steps in method 900. If MATRIX[ROW(x),j] is true, pseudo code 1300 returns “false”. If MATRIX[ROW(x),j] is false, pseudo code 1300 returns “true”. When pseudo code 1300 returns “true”, the pointers may be aliases.

A pointer that has no aliases is the only access path to whatever memory locations it is used to access. Compilers that can determine whether pointers are aliases for the same memory location can reliably optimize a code segment. In one embodiment of the invention, only two pointers at a time are checked for aliasing. In another embodiment, each pointer is checked against every other pointer in a code segment for aliasing.

One form of optimization is instruction reordering. A compiler performs instruction reordering by changing the instruction execution sequence to take advantage of a computer's method for executing instructions. For example, if a computer can perform multiple fetches simultaneously, the compiler may reorder instructions such that the fetches are simultaneously executed first, with the potential benefit of decreasing execution time. However, when instructions are reordered, a compiler must insure that data is not lost, and that results are reliable. For example, if multiple fetches are reordered, a fetch instruction may retrieve data from a memory location that depended upon begin updated by subsequent instructions. Therefore, the program may return unreliable results. Thus a compiler must assume data dependences unless it can prove otherwise. Alias analysis is a technique for removing assumed dependences. Alias analysis that considers restricted pointers on inner scopes can often remove more assumed dependences from consideration than analysis that considers only restricted pointers on outer blocks. Having fewer assumed dependences puts fewer constraints on reordering of instructions. Thus the present invention permits greater optimization. On case of particular note is FORTRAN, for which the addresses of formal parameters behave as restricted pointers. FORTRAN, as a source language, has no notion of inner scopes. However, a compiler may “inline” a FORTRAN subroutine f into another routine g, which means to copy the instructions of f into the call site to f inside g. In such a situation, the copied instructions acquire their own inner scope inside the scope of g, which the present invention can exploit.

Thus, a method and apparatus for alias analysis for restricted pointers have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
receiving a code segment having a plurality of instructions, the code segment having an outer scope and a number of inner scopes, wherein the plurality of instructions comprise a number of pointers, wherein at least one of the number of pointers is restricted; and
determining, within one of the number of inner scopes, whether at least two pointers of the number of pointers are aliases.

2. The method of claim 1, comprising determining a base pointer for each pointer of the number of pointers.

3. The method of claim 2, wherein the determining a base pointer for each pointer of the number of pointers comprises:
grouping pointers together upon determining that the pointers are copied to a pointer that is not a restricted pointer.

4. The method of claim 3, wherein there is no grouping of pointers when the pointers have distinct base pointers.

5. The method of claim 3, comprising for each instruction of the plurality of instructions that accesses a pointer, determining which at least one restricted pointer is within the scope of the pointer when the pointer is accessed.

6. The method of claim 4, wherein the determining, within one of the number of inner scopes, whether at least two pointers of the number of pointers are aliases is based on the base pointer for each of the number of pointers.

7. The method of claim 3, wherein the determining, within one of the number of inner scopes, whether at least two pointers of the number of pointers are aliases is based on, for each instruction of the plurality of instructions that accesses the pointer, which at least one restricted pointer is within the scope of the pointer, when the pointer is accessed.

8. A method comprising:
receiving a code segment having a plurality of instructions, wherein the plurality of instructions comprise a number of pointers, wherein at least one of the number of pointers is restricted, and wherein the at least one restricted pointer is in-scope or out-of-scope; and
determining whether at least two pointers of the number of pointers are aliases when each pointer of the at least two pointers is out-of-scope relative to the other pointers of the at least two pointers.

9. The method of claim 8 comprising determining a base pointer for each pointer of the number of pointers.

10. The method of claim 9, comprising determining, for each pointer of the number of pointers, whether each at least one restricted pointer is in-scope when the pointer of the number of pointers is accessed.

11. The method of claim 10 wherein the determining whether at least two pointers of the number of pointers are aliases is based on determining a base pointer for each pointer of the number of pointers.

12. The method of claim 10 wherein the determining whether at least two pointers of the number of pointers are aliases is based on determining a base pointer for each pointer of the number of pointers, and on determining for each pointer of the number of pointers whether each at least one restricted pointer is in-scope when the pointer is accessed.

13. A system comprising:
a memory unit to include a code segment having a plurality of instructions, the code segment having an outer scope and a number of inner scopes, wherein the plurality of instructions comprise a number of pointers, wherein at least one of the number of pointers is restricted; and
a compiler unit coupled to the memory, the compiler unit to determine within one of the number of inner scopes, whether at least two pointers of the number of pointers are aliases.

14. The system of claim 13, wherein the compiler unit is to determine a base pointer for each pointer of the number of pointers.

15. The system of claim 14, wherein the compiler unit is to determine, for each instruction of the plurality of instructions that accesses a pointer, which at least one restricted pointer is within the scope of the pointer when the pointer is accessed.

16. The system of claim 15, wherein the compiler unit is to determine, within one of the number of inner scopes, whether at least two pointers of the number of pointers are aliases based on, for each instruction of the plurality of instructions that accesses a pointer, which of the restricted pointers is within the scope of the pointer when the pointer is accessed.

17. A machine-readable medium that provides instructions, which when executed by a machine, cause said machine to perform operations comprising:
receiving a code segment having a plurality of instructions, the code segment having an outer scope and a number of inner scopes, wherein the plurality of instructions comprise a number of pointers, wherein at least one of the number of pointers is restricted; and
determining, within one of the number of inner scopes, whether at least two pointers of the number of pointers are aliases.

18. The machine-readable medium of claim 17, comprising determining a base pointer for each pointer of the number of pointers.

19. The machine-readable medium of claim 18, comprising for each instruction of the plurality of instructions that accesses a pointer, determining which at least one restricted pointer is within the scope of the pointer when the pointer is accessed.

20. The machine-readable medium of claim 19, wherein the determining, within one of the number of inner scopes, whether at least two pointers of the number of pointers are aliases is based on the base pointer for each of the number of pointers.

21. The machine-readable medium of claim 19, wherein the determining, within one of the number of inner scopes, whether at least two pointers of the number of pointers are aliases is based on, for each instruction of the plurality of instructions that accesses the pointer, which at least one restricted pointer is within the scope of the pointer, when the pointer is accessed.

22. A machine-readable medium that provides instructions, which when executed by a machine, cause said machine to perform operations comprising:
receiving a code segment having a plurality of instructions, wherein the plurality of instructions comprise a number of pointers, wherein at least one of the number of pointers is restricted, and wherein the at least one restricted pointer is in-scope or out-of-scope; and
determining whether at least two pointers of the number of pointers are aliases when each pointer of the at least two pointers is out-of-scope relative to other pointers of the at least two pointers.

23. The machine-readable medium of claim 22, comprising determining a base pointer for each pointer of the number of pointers.

24. The machine-readable medium of claim 23, comprising determining, for each pointer of the number of pointers, whether each at least one restricted pointer is in-scope when the pointer of the number of pointers is accessed.

25. The machine-readable medium of claim 24, wherein the determining, within one of the number of inner scopes, whether at least two pointers of the number of pointers are aliases is based on the base pointer for each of the number of pointers.

26. The machine-readable medium of claim 24, wherein the determining whether at least two pointers of the number of pointers are aliases is based on determining a base pointer for each pointer of the number of pointers, and on determining for each pointer of the number of pointers whether each at least one restricted pointer is in-scope when the pointer is accessed.
